(19) United States
(12) Patent Application Publication
(10) Pub. No.: US 2016/0067882 A1
(43) Pub. Date: Mar. 10, 2016

(54) DEVICE FOR LONGITUDINAL PROCESSING OF WOOD FOR THE PRODUCTION OF A WOOD COMPOSITE

(71) Applicants: Wojciech KOKOCINSKI, Poznan (PL); Michal Marcin JANOWSKI, Poznan (PL); Andrzej Jan SIANKOWSKI, Jarocin (PL)

(72) Inventors: Wojciech KOKOCINSKI, Poznan (PL); Michal Marcin JANOWSKI, Poznan (PL); Andrzej Jan SIANKOWSKI, Jarocin (PL)

(21) Appl. No.: 14/787,609

(22) PCT Filed: Apr. 30, 2014
(86) PCT No.: PCT/PL2014/000046

§ 371 Date: Oct. 28, 2015

(30) Foreign Application Priority Data
Apr. 30, 2013 (PL) P-403730

(51) Int. Cl. B27L 11/08; B27M 1/08; B27L 7/02

(52) U.S. Cl. CPC B27L 11/08; B27L 7/02; B27M 1/08

(57) ABSTRACT

Disclosed is a device having four processing modules, arranged one behind another. Consecutive modules longitudinally cut wooden poles to narrower pieces. Each module has at least two corrugated feeding cylinders, at least one cutting apart wedge disc located behind them, optionally at least one fixed separating wedge located behind the cutting apart wedge disc, at least a cylinder distributing the longitudinally cut wooden poles and at least one cylinder crushing bundles of fibres of the longitudinally cut wood. There is a support and transport line situated along the workpiece transport route in each processing module. In case of a larger number of wedge discs in a processing module, the cutting apart wedge discs are situated on two opposite sides of the feed path and separated in a 2:1 ratio on the two sides of the feed path of the workpiece being cut apart.

The subject of the invention is an innovative modular device for longitudinal grinding of wood in the form of bands of fibres used then for production of the “lignolit” wood composite by binding into boards or beams.

From the Polish patent no PL159711, there is known a process of grinding plant stems, especially wood in the process of production of lignocellulosic materials and a device for grinding stems.

The device consists of a few units, serially arranged in a row, formed by pairs of cylinders situated one over another. Each unit is formed by a pair of profiled cylinders with slidingly overpulled wedge discs and a pair of spreading pressure cylinders with a thread winding starting at the half of the length of the cylinder, with profiled cylinders in each consecutive unit having a bigger number of discs with a smaller height of wedges per unit of length. The solution enables to produce a matt composed of plant fibres, longitudinally separated into bands, having similar thickness and length equal to the length of the stem being ground. After gluing together the material so prepared, wood composite in the form of boards or beams practically of any dimensions and featuring strength close to that of the input material is produced.

From the European patent no EP0666155, there are known wooden elements composed of pieces of wood, a method of producing it and a production device. The device for the production of wooden elements consists of a unit for the transverse cutting of a pole of wood or bamboo or another material, a unit for coarse separation of the pole along fibres and then a unit for a consecutive, final separation. The consecutive units are a ground wood drying unit, a glue application and formation unit and a unit for gluing wooden elements together by pressing. The longitudinal separation unit contains a pair of rotating blades placed on rotating drums.

Each blade has a cutting edge featuring the inclination angle of 20 degrees.

From the international patent application no WO2012042028, there is known a device for producing wooden fibres from logs. The device contains at least one pair of rollers placed on opposite sides of a wooden log which cut the band and to a large degree extend in a peripheral direction. The length of the blades for cutting the band increases starting from the axis of the cylinder in at least one roller of the pair of cylinders towards the edge of the cylinder and decreases in the axial direction towards the centre of the roller.

From the international patent application no WO8502367, there is known a device for separating wood into flexible bands of fibres principally parallel to one another. The device contains a pair of rotating rollers which are remote from each other and parallel to each other and which furthermore perform reciprocating movements in a direction parallel to the rollers' rotation axis.

The essence of the invention is a modular structure of the device for longitudinal grinding of wood. The device consists of four grinding modules, arranged one behind another. Consecutive modules grind poles of smaller thickness. Each module consists of at least two corrugated feeding cylinders (3), at least one wedge disc (1) located behind them, at least one fixed separating wedge (2) located immediately behind the wedge disc (1), at least two cylinders distributing (4) the transversely separated wood poles and at least one cylinder crushing (5) bundles of fibres of the transversely separated wood. There is a support and transport line (6) situated along the pole transport route in the grinding module. In a preferable variant, the support and transport line is composed of a unit of cylinders, the rotation axes of which are parallel to one another. Preferably, the number of cylinders in the support and transport line (6) is not smaller than 2. The cylinders in the support and transport line are provided with guiding rings.

In another variant, the support and transport line is a caterpillar conveyor. The corrugated feeding cylinders (3) are located on the edge of the grinding module and are situated at least from the top of the pole being ground. The corrugated feeding cylinders can be arranged both from the top as well as from the bottom of the pole being ground while the distance between the surfaces of the cylinders is adjustable and in order to match the diameter of the pole being ground. The force of cylinders' pressure against the pole is controlled by the resilience of the pressure screw spring and it does not exceed 1000 daN. The grinding module contains at least one wedge disc (1) for longitudinally cutting apart the pole, while the wedge disc can be located from the top as well as from the bottom of the pole being cut apart. In case of a larger number of wedge discs (1) in the grinding module, the cutting apart discs are situated on two opposite sides of the pole and separated in the 2:1 ratio on the two sides of the pole being cut apart. The diameter of the wedge discs (1) depends on the diameter of the poles being ground and ranges from 100 mm to 400 mm. The wedge discs (1) are placed on cylinders. At least a part of the support and transport cylinders (6) and all feeding cylinders (3), transversely distributing cylinders (4), crushing cylinders (5) and the cylinder with the wedge discs (1) are propelled and the rotational speed of the cylinders is adjusted in an infinitely variable manner.

The modular structure of the device allows adapting the device to the diameter of raw material being ground and the expected dimensions of the ground bands of fibres. The bigger the diameter of the poles being ground, the more modules should be employed in the grinding line and each module performs grinding into finer parts.

The object of the invention is presented as embodiments on the drawing on which

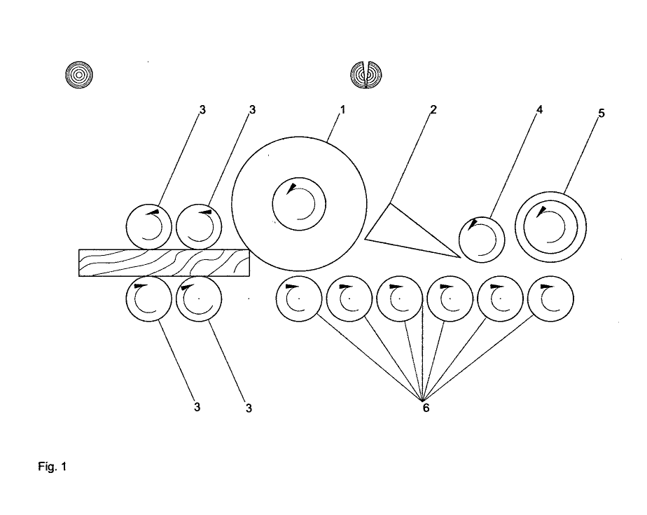

FIG. 1 presents a schematic of a coarse grinding module with one wedge disc situated above the pole,

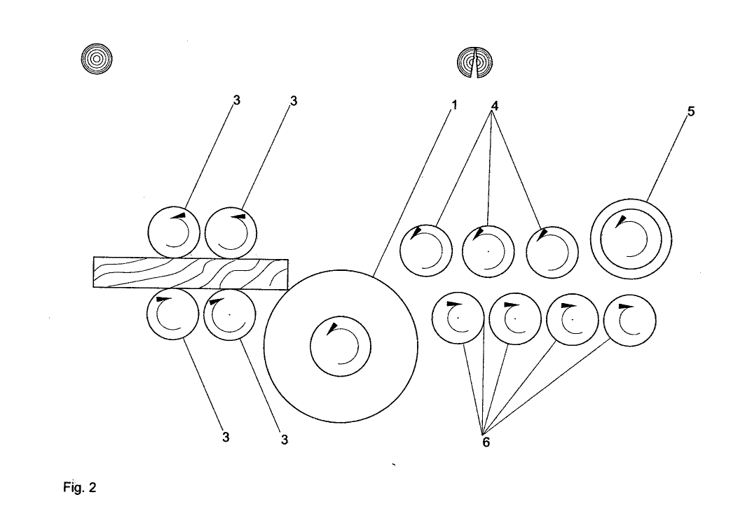

FIG. 2 presents a schematic of a coarse grinding module with one wedge disc situated below the pole,

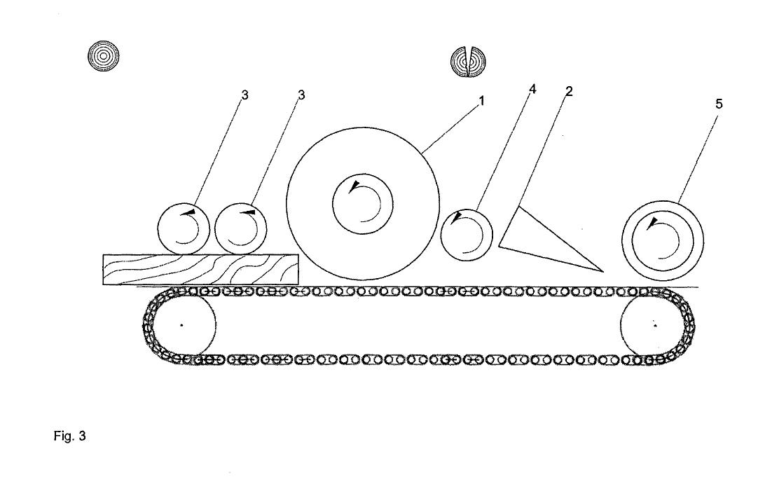

FIG. 3 presents a schematic of a coarse grinding module with a caterpillar conveyor,

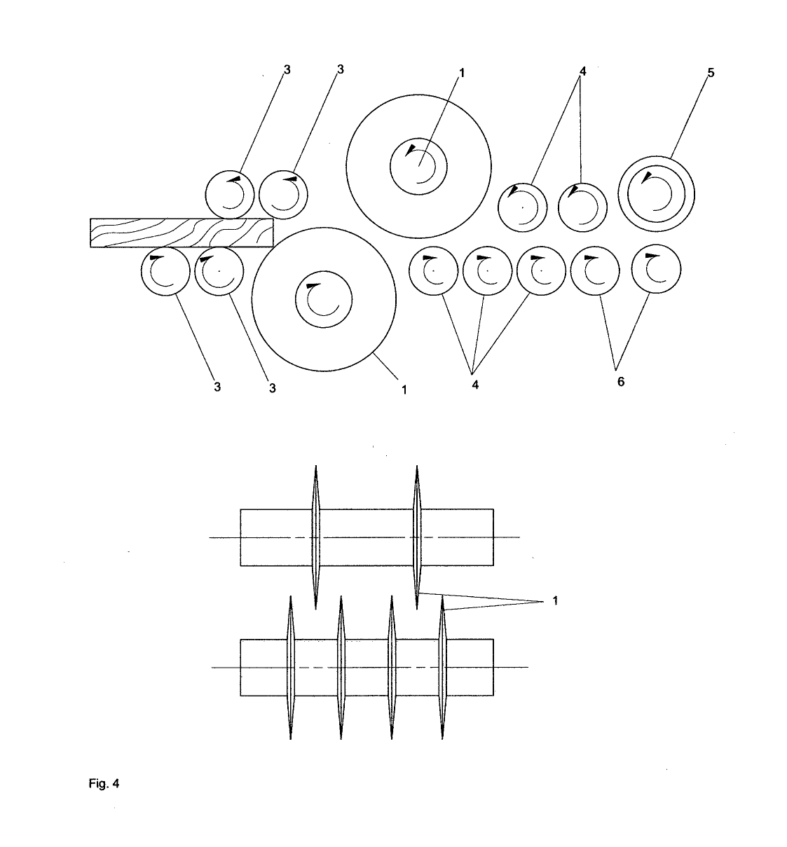

FIG. 4 presents the first intermediate grinding module,

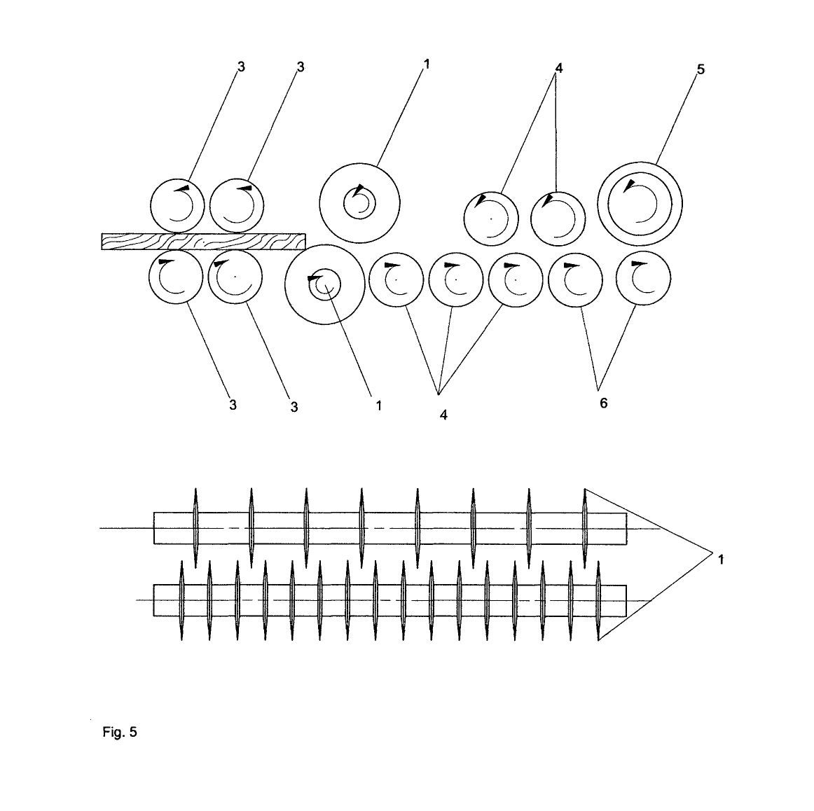

FIG. 5 presents the second intermediate grinding module,

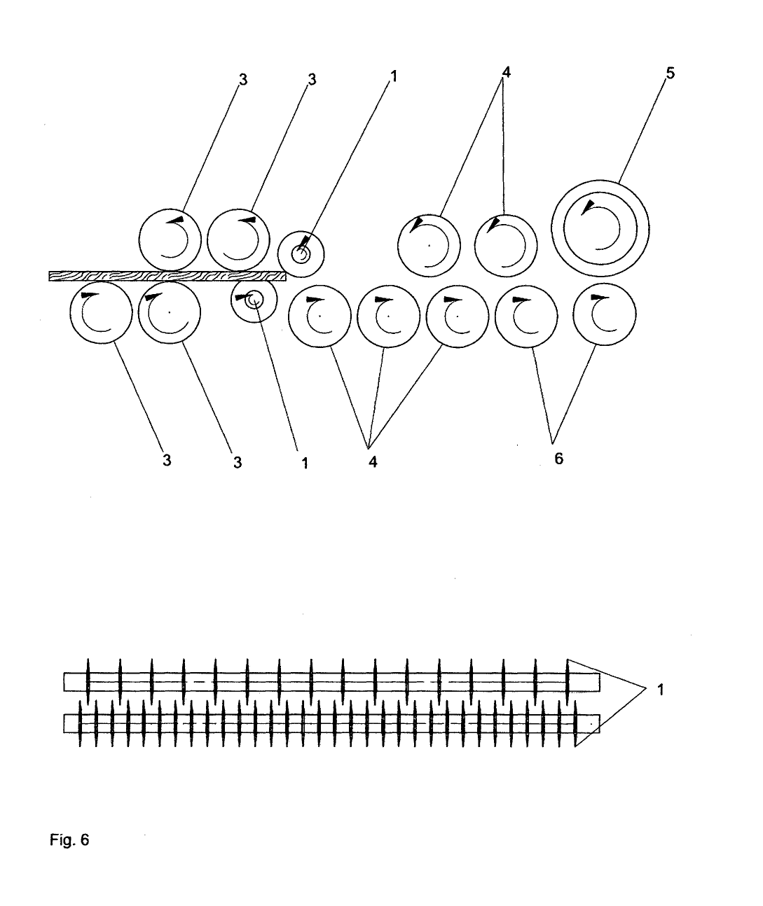

FIG. 6 presents the end grinding module.

The coarse grinding module presented in FIG. 1 has two pairs of corrugated feeding cylinders 3, arranged in pairs, on both sides of the pole being ground, one wedge disc 1 with the diameter of 400 mm with the rotation axis situated above the pole. Immediately behind the wedge disc 1, there is situated a fixed separating wedge 2, a transversely distributing cylinder 4 with the rotation axis situated above the pole and a crushing cylinder 5 with the rotation axis situated above the pole. A set of six support and transport cylinders is situated below the pole.

The coarse grinding module presented in FIG. 2 has two pairs of corrugated feeding cylinders 3, arranged in pairs on both sides of the pole being ground, one wedge disc 1 with the diameter of 400 mm with the rotation axis situated below the pole. Immediately behind the wedge disc 1, there is situated a set of transversely distributing cylinders 4 with the rotation axis situated above the pole and a crushing cylinder 5 with the rotation axis situated above the pole. A set of four support and transport cylinders is situated below the pole.

The coarse grinding module presented in FIG. 3 has one pair of corrugated feeding cylinders 3 arranged on one side of the pole being ground, one wedge disc 1 with the diameter of 400 mm with the rotation axis situated above the pole. Immediately behind the wedge disc 1, there is situated the transversely distributing cylinder 4 with the rotation axis situated above the pole and the fixed separating wedge 2 and the crushing cylinder 5 with the rotation axis situated above the pole. A support and transport caterpillar conveyor is situated below the pole.

The first intermediate grinding module presented in FIG. 4 has two pairs of corrugated feeding cylinders 3, arranged in pairs on both sides of the pole being ground, the upper shaft with two wedge discs 1 with the diameter of 300 mm and the lower shaft with four wedge discs with the diameter of 300 mm. Immediately behind the shafts with the wedge discs 1, there are sets of distributing cylinders 4 situated on both sides of the pole and the crushing cylinder 5 with the rotation axis situated above the pole. A set of two support and transport cylinders is situated below the pole.

The second intermediate grinding module presented in FIG. 5 has two pairs of corrugated feeding cylinders 3, arranged in pairs on both sides of the pole being ground, the upper shaft with eight wedge discs 1 with the diameter of 200 mm and the lower shaft with sixteen wedge discs with the diameter of 200 mm. Immediately behind the shafts with the wedge discs 1, there are sets of distributing cylinders 4 situated on both sides of the pole and the crushing cylinder 5 with the rotation axis situated above the pole. A set of two support and transport cylinders is situated below the pole.

The end grinding module presented in FIG. 6 has two pairs of corrugated feeding cylinders 3, arranged in pairs on both sides of the pole being ground, the upper shaft with sixteen wedge discs 1 with the diameter of 100 mm and the lower shaft with thirty two wedge discs with the diameter of 100 mm. Immediately behind the shafts with the wedge discs 1, there are sets of distributing cylinders 4 situated on both sides of the pole and the crushing cylinder 5 with the rotation axis situated above the pole. A set of two support and transport cylinders is situated below the pole.

1. An innovative modular device for longitudinal grinding of wood for the production of the “lignolit” wood composite, having feeding cylinders, a wedge disc, cylinders distributing the transversely separated wood poles and a cylinder crushing the bundles of fibres of longitudinally separated wood, characterised in that the device comprises four modules and each module comprises at least two corrugated feeding cylinders, at least one wedge disc situated behind them, at least one fixed separating wedge situated immediately behind the wedge disc, at least two cylinders distributing the transversely separated poles of wood and at least one cylinder crushing the bundles of fibres of longitudinally separated wood while along the transport route of the pole in the grinding module, there is situated the support and transport line, where, in case when the number of wedge discs is bigger than the one in the grinding module, the cutting-apart discs are arranged on two opposite sides of the pole and separated in the 2:1 ratio on the two sides of the pole being cut apart and the diameter of the wedge discs depends on the diameter of the poles being ground and ranges from 100 mm to 400 mm.

2. The device according to claim 1, characterised in that the support and transport line is composed of a set of cylinders, the rotation axes of which are parallel to one another.

3. The device according to claim 2, characterised in that the cylinders in the support and transport line are provided with guiding rings.

4. The device according to claim 2, characterised in that the number of the cylinders in the support and transport line is not smaller than 2.

5. The device according to claim 1, characterised in that the support and transport line is a caterpillar conveyor.

6. The device according to claim 1, characterised in that the diameter of the wedge discs depends on the diameter of the poles being ground and ranges from 100 mm to 400 mm.

7. The device according to claim 1, characterised in that at least a part of the support and transport cylinders and all feeding cylinders, transversely distributing cylinders, crushing cylinders and the cylinder with the wedge discs are propelled and the rotational speed of the cylinders is adjusted in an infinitely variable manner.
